(19) United States
(12) Patent Application Publication
(10) Pub. No.: US 2012/0327445 A1
(43) Pub. Date: Dec. 27, 2012

(54) INFORMATION PROCESSING APPARATUS, INFORMATION PROCESSING METHOD AND STORAGE MEDIUM

(75) Inventor: Hiroshi Kikuchi, Tokyo (JP)

(73) Assignee: CANON KABUSHIKI KAISHA, Tokyo (JP)

(21) Appl. No.: 13/528,451

(22) Filed: Jun. 20, 2012

(30) Foreign Application Priority Data
Jun. 23, 2011 (JP) 2011-139736

(51) Int. Cl. G06K 15/02

(52) U.S. Cl. 358/1.13

(57) ABSTRACT

An information processing method includes acquiring an installed driver set, displaying an input screen for inputting a character string thereto, creating a new driver set by editing the acquired driver set based on the character string input to the input screen, and replacing the installed driver set with the new driver set created by the creating step.

### BACKGROUND OF THE INVENTION

1. Field of the Invention

The present invention relates to an information processing apparatus operated by a driver, and to an information processing method and a storage medium.

2. Description of the Related Art

A printer is usually controlled by software called a printer driver, which operates on a personal computer (PC). The printer driver has two major functions. One of the functions is to enable a user to change a print setting, and generally has a user interface (UI). Another function is to convert a drawing command provided from an application into data (e.g., page description language (PDL)) interpretable by a printer, and transmit the converted data to the printer.

Further, among printer drivers for a Windows (trademark) operating system (OS), a Generic Printer Description (GPD) based printer driver has been available. In the GPD-based printer driver, a Windows OS generates a printer driver UI based on a GPD file in a text format created by a printer manufacturer. Such a GPD-based printer driver is expected to be a major printer driver for Windows OS in the future from a high security standpoint.

Since a printer driver is produced and distributed by a printer manufacturer, to customize a UI afterward is generally difficult. Japanese Patent No. 4,574,344 discusses a technique in which a UI of a printer driver can be customized afterward.

The GPD-based printer driver, however, has a problem in which the driver cannot create a UI for enabling a user to input an arbitrary character string. For example, specifications do not allow creation of a UI for enabling a user to input a character string to be displayed on a main body panel at the time of printing as a print setting of a printer driver. Since the specifications of the GPD enable a user to designate a print setting only from existing options described in the GPD. Japanese Patent No. 4,574,344 further discusses a process in which a number of options can be increased before installation of a printer driver. In such a method, a user needs to prepare an additional driver set for before installation, and needs to perform additional installation work. Consequently, such a method is not convenient to the user. In addition, a printer driver using a PostScript Printer Description (PPD) in a format similar to the GPD has the similar problem.

### SUMMARY OF THE INVENTION

According to an aspect of the present invention, an information processing apparatus includes an acquisition unit that acquires an installed driver set, a display unit that displays an input screen for inputting a character string thereto, a creation unit that creates a new driver set by editing the driver set acquired by the acquisition unit based on the character string input to the input screen, and a replacement unit that replaces the installed driver set with the new driver set created by the creation unit.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a hardware configuration according to a present exemplary embodiment.

FIG. 2 is a block diagram illustrating a software configuration according to the present exemplary embodiment.

FIG. 3 is a schematic diagram illustrating a driver store in detail.

FIG. 4 is a diagram illustrating an example of a GPD-based printer driver UI.

FIG. 5 is a diagram illustrating an example of a GPD file.

FIG. 6 is a diagram illustrating a printer driver UI (before editing) according to the present exemplary embodiment.

FIG. 7 is a flowchart illustrating the entire operation of a driver replacement tool.

FIG. 8 is a diagram illustrating an example of a printer selection screen.

FIG. 9 is a diagram illustrating an editing UI (before editing) according to the present exemplary embodiment.

FIG. 10 is a diagram illustrating an excerpt of the GPD file (before editing) according to the present exemplary embodiment.

FIG. 11 is a flowchart illustrating operation of the driver replacement tool to generate a tree display.

FIG. 12 is a diagram illustrating an arbitrary character string input screen to be displayed by the driver replacement tool.

FIG. 13 is a diagram illustrating the editing UI (after editing) according to the present exemplary embodiment.

FIG. 14 is a diagram illustrating an excerpt of the GPD file (after editing) according to the present exemplary embodiment.

FIG. 15 is a diagram illustrating the printer driver UI (after editing) according to the present exemplary embodiment.

FIG. 16 is a diagram illustrating a warning dialog indicating a printer to be replaced.

FIG. 17 is a diagram illustrating a warning dialog indicating that printer replacement cannot be made.

FIG. 18 is a diagram illustrating a warning dialog indicating that a printer will be replaced with another name.

FIG. 19 is a diagram illustrating an example of a GPD-based printer driver UI.

FIG. 20 is a diagram illustrating an example of a PPD file (before editing).

FIG. 21 is a diagram illustrating an example of the PPD file (after editing).

FIG. 22A is a diagram illustrating a movement of a file in step S602 of the flowchart illustrated in FIG. 7.

FIG. 22B is a diagram illustrating a movement of the file in step S605 of the flowchart illustrated in FIG. 7.

FIG. 22C is a diagram illustrating a movement of the file in step S606 of the flowchart illustrated in FIG. 7.

### DESCRIPTION OF THE EMBODIMENTS

Various exemplary embodiments, features, and aspects of the invention will be described in detail below with reference to the drawings.

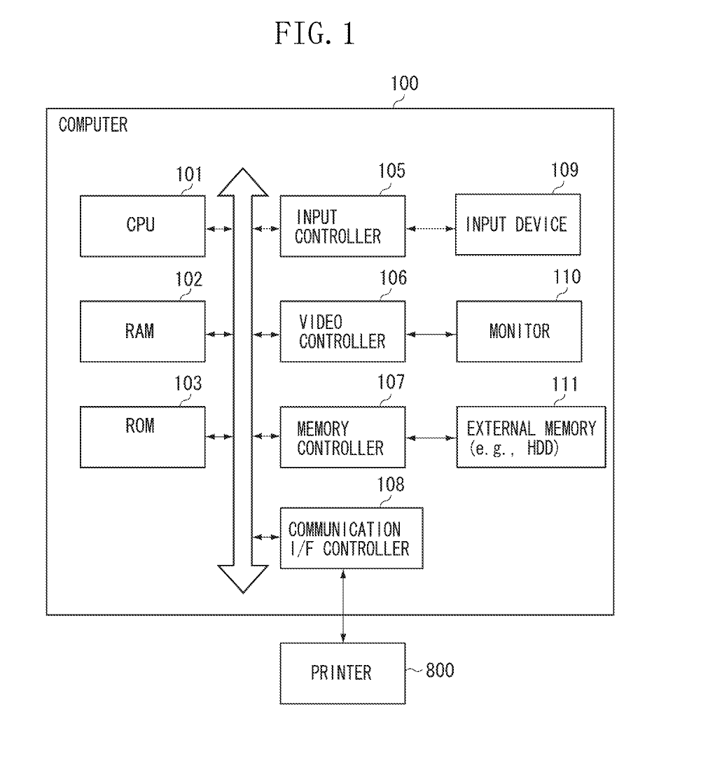

FIG. 1 is a block diagram illustrating a hardware configuration of a print system according to a present exemplary embodiment. A computer 100 and a printer 800 are connected via a network or a universal serial bus (USB). A central processing unit (CPU) 101 comprehensively controls devices and controllers connected to a system bus 104. A random access memory (RAM) 102 functions as a main memory and a work memory of the CPU 101.

A read only memory (ROM) 103 stores therein, for example, a basic input output system (BIOS) of the computer 100. An input controller 105 controls an input device 109 such as a mouse and a keyboard. A video controller 106 controls a display on a monitor 110. A memory controller 107 controls reading from and writing to an external memory 111 such as a hard disk drive (HDD). A communication interface (I/F) controller 108 controls a communication interface to an external device.

Various programs to realize the present invention are stored in the external memory 111. Each of the programs is loaded to the RAM 102 and executed by the CPU 101 as needed.

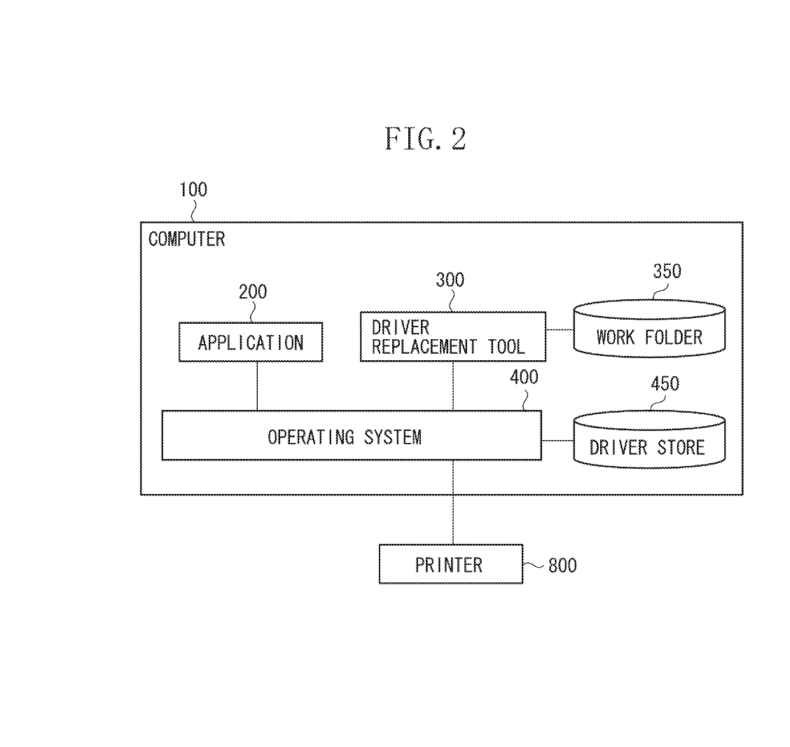

FIG. 2 is a block diagram illustrating a software configuration inside the computer 100 according to the present exemplary embodiment. An operating system 400 controls various software and hardware. In the present exemplary embodiment, the operating system 400 is a Windows (trademark) OS. An application 200 is software for document preparation or spreadsheet, for example. The application 200 can also provide a print instruction to the printer 800 using a function of the operating system 400.

A driver replacement tool 300 is software that embodies the present invention. The driver replacement tool 300 operates as one application while using a storage area called a work folder 350. The operating system 400 manages a printer driver prepared for controlling the printer 800, and stores a file group of printer drivers for respective printers in a storage area called a driver store 450. The work folder 350 and the driver store 450 are located in the external memory 111.

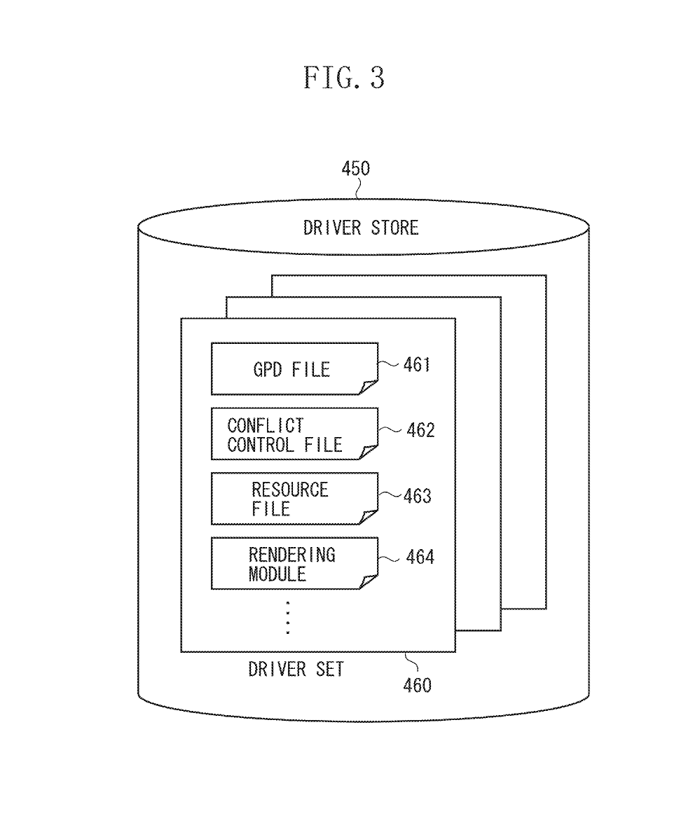

FIG. 3 is a schematic diagram illustrating the driver store 450 in detail. The driver store 450 stores therein a driver set 460. The driver sets 460 are stored in the driver store 450 as many as the number of printer drivers installed in the computer 100. If a driver set is a GPD-based printer driver, for example, the printer driver includes files illustrated in FIG. 3. In a GPD file 461, a print setting unique to a printer is described in text. In a conflict control file 462, a prohibition specification applied to a combination of print settings is described in text. A resource file 463 contains a resource such as a character string on a printer driver UI. The operating system 400 generates a printer driver UI based on the GPD file 461 or the resource file 463 as needed, and displays the generated printer driver UI on the monitor 110. Accordingly, a user can edit the print setting using the printer driver UI before printing.

A rendering module 464 converts a drawing command into data (PDL) interpretable by the printer 800 when printing is performed by the application 200.

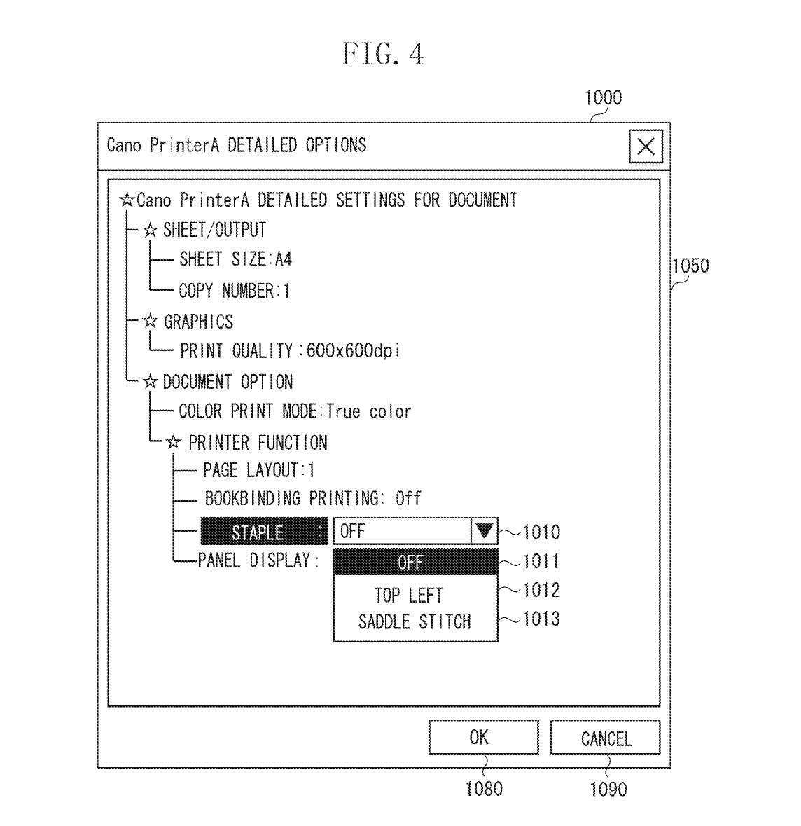

FIG. 4 illustrates an example of a GPD-based printer driver UI. A printer driver UI 1000 is displayed in a dialog format by the operating system 400. A print setting is displayed in a tree format in an area 1050 illustrated in FIG. 4. FIG. 4 illustrates a case where a user selects an item “STAPLE:” 1010 in the print setting. The item “STAPLE:” 1010 has a combo box in which three print setting items such as an item “OFF” 1011, an item “TOP LEFT” 1012, and an item “SADDLE STICH” 1013 are arranged, so that the user can select an arbitrary item. The printer driver UI 1000 includes an “OK” button 1080 and a “CANCEL” button 1090. For example, when the user presses the “OK” button 1080, a print setting displayed on the printer driver UI 1000 is stored. When the user presses the “CANCEL” button 1090, a print setting displayed on the printer driver UI 1000 is discarded. The stored print setting is used by the operating system 400 at the time of printing.

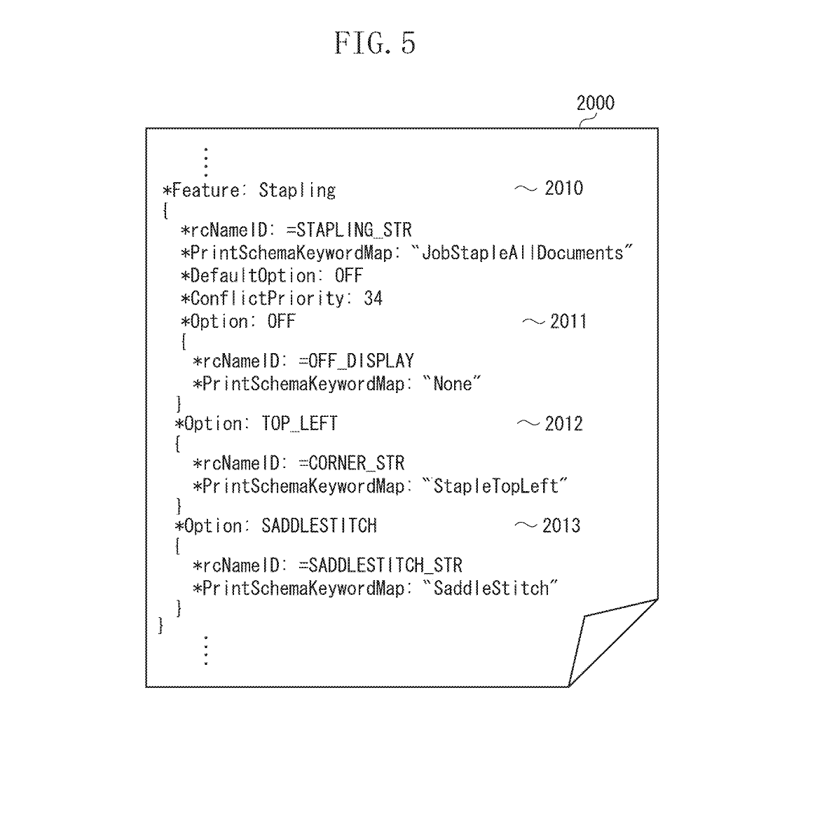

FIG. 5 illustrates an example of a GPD file. A GPD file 2000 is excerpted from the GPD file corresponding to the printer driver UI 1000 illustrated in FIG. 4. In the GPD file 2000, a combination of a print setting called Feature and a print setting item called Option is described. As illustrated in FIG. 5, three Option items such as an item “OFF” 2011, an item “TOP LEFT” 2012, and an item “SADDLESTITCH” 2013 are described with respect to “Stapling” 2010 serving as the Feature. The operating system 400 generates the printer driver UI 1000 illustrated in FIG. 4 using the GPD file 2000 or the resource file 463.

Now, a detailed description is given of the driver replacement tool 300 according to the present exemplary embodiment of the present invention. The driver replacement tool 300 operates as one application in a process different from that of a printer driver.

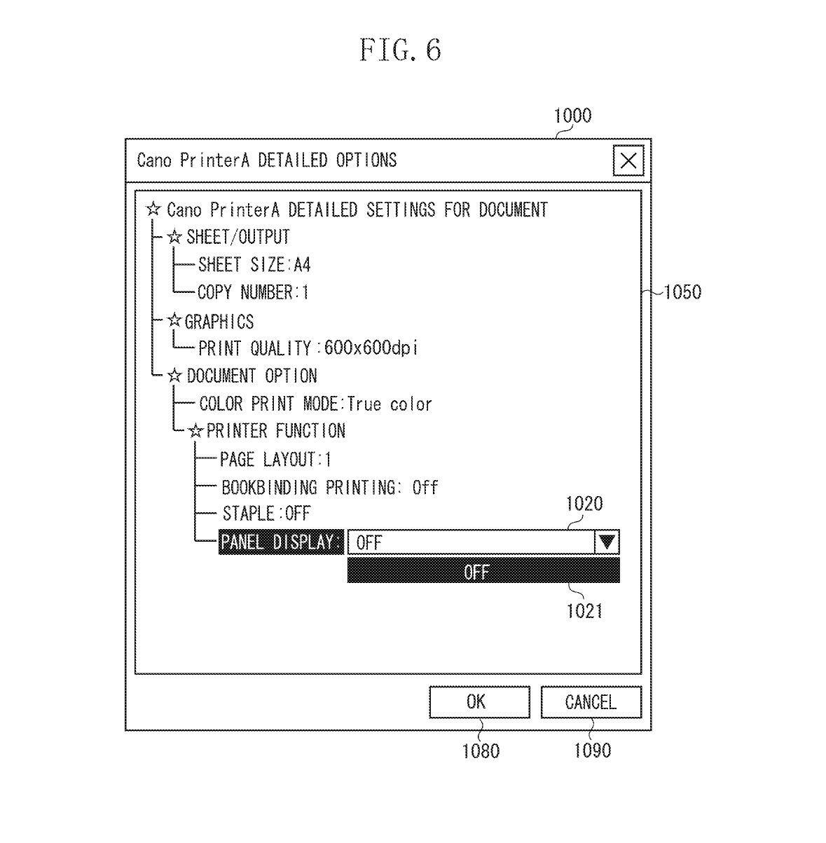

FIG. 6 is a diagram illustrating a printer driver UI before the driver replacement tool 300 is used. FIG. 6 illustrates the printer driver UI 1000 at the time of selection of an item “PANEL DISPLAY:” 1020 whereas FIG. 4 illustrates the printer driver UI 1000 at the time of selection of the item “STAPLE:” 1010. The item “PANEL DISPLAY:” 1020 has only an item “OFF” 1021 as an option. Herein, the user closes the printer driver UI 1000 by pressing the “CANCEL” button 1090, for example, and executes the driver replacement tool 300 so that the user can input an arbitrary character string into the item “PANEL DISPLAY:” 1020.

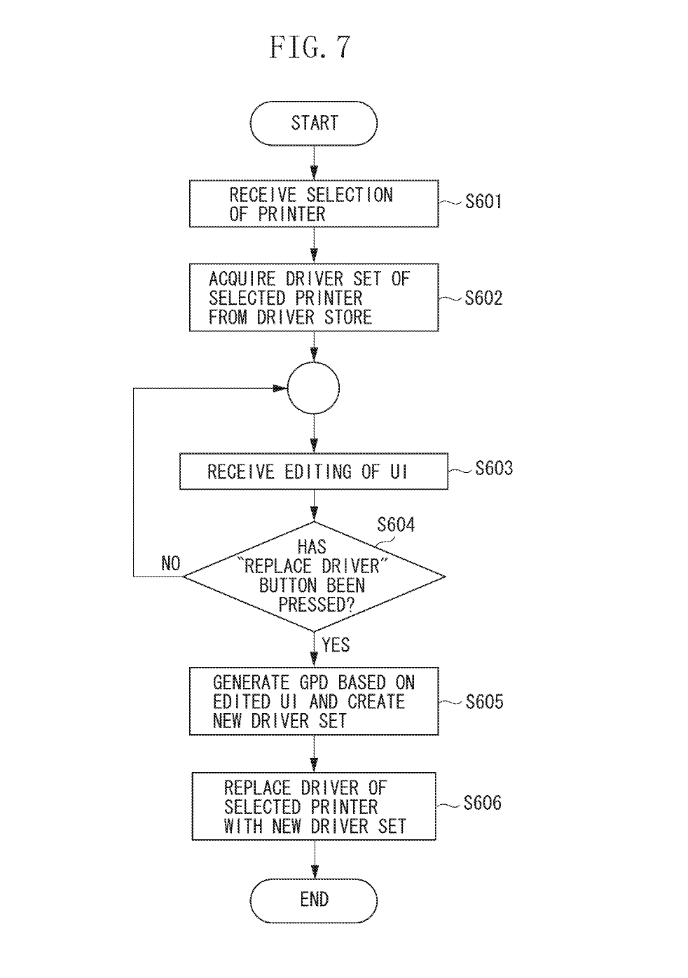

FIG. 7 is a flowchart illustrating the entire operation of the driver replacement tool 300.

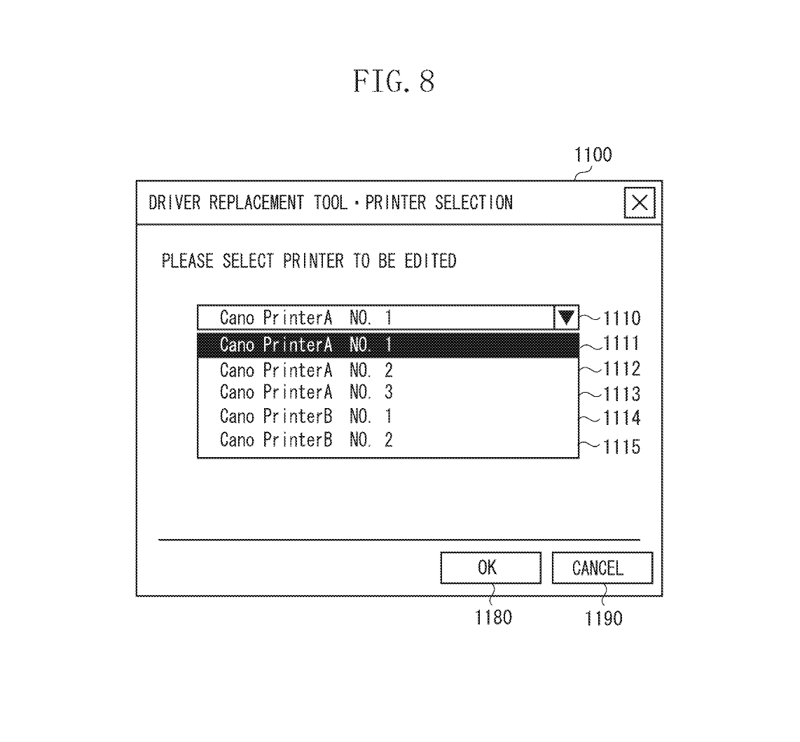

In step S601, the driver replacement tool 300 receives a selection of the printer to be edited from the user upon activation. FIG. 8 is an example of a printer selection screen 1100 to be displayed in step S601. The driver replacement tool 300 acquires a list of the installed printer drivers from the operating system 400, and adds only a GPD-based printer driver within the list as an item to a combo box 1110. On the printer selection screen 1100 illustrated in FIG. 8, for example, three printers called “Cano PrinterA” as items 1111, 1112, and 1113, and two printers called “Cano PrinterB” as items 1114 and 1115 are displayed, and each of these printers is connected to the computer 100. When the user selects a printer and presses an “OK” button 1180, the operation proceeds to step S602. Meanwhile when a “CANCEL” button 1190 is pressed, the operation ends.

In step S602, the driver replacement tool 300 acquires an installed driver set for the selected printer from the driver store 450. Specifically, the driver replacement tool 300 first acquires a printer model name from the selected printer. The driver replacement tool 300 then acquires a storage location of the driver set 460 inside the driver store 450 managed by the operating system 400 based on the model name. Subsequently, the driver replacement tool 300 copies the entire file group of the driver set 460 to the work folder 350.

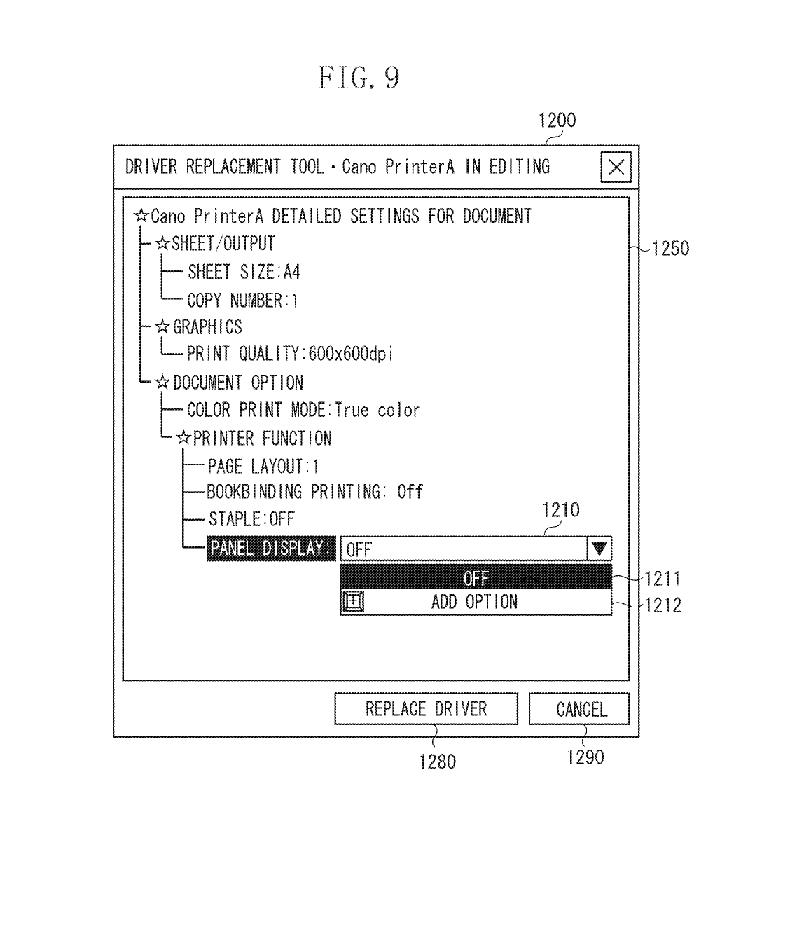

In step S603, the driver replacement tool 300 receives editing of the UI. FIG. 9 illustrates a setting screen 1200 to be displayed by the driver replacement tool 300 to receive the editing of the UI from the user. The driver replacement tool 300 generates a UI 1250 based on the GPD file 461 copied to the work folder 350 in step S602. The UI 1250 is displayed in a unique tree format similar to the tree display 1050 of the printer driver. As illustrated in FIG. 9, a combo box 1210 for “PANEL DISPLAY:” has a list including an item “OFF” 1211 and an item “+ADD OPTION” 1212. In practice, the item “+ADD OPTION” 1212 is not displayed on the tree display 1050 of the printer driver. The item “+ADD OPTION” 1212 is added by the driver replacement tool 300 originally. Accordingly, when the user selects a button for the item “+ADD OPTION” 1212, a character string can be added as an option to the combo box for the “PANEL DISPLAY:”. An option may not be added to each of all the combo boxes for print settings. A print setting which can be added may be determined beforehand by a GPD file.

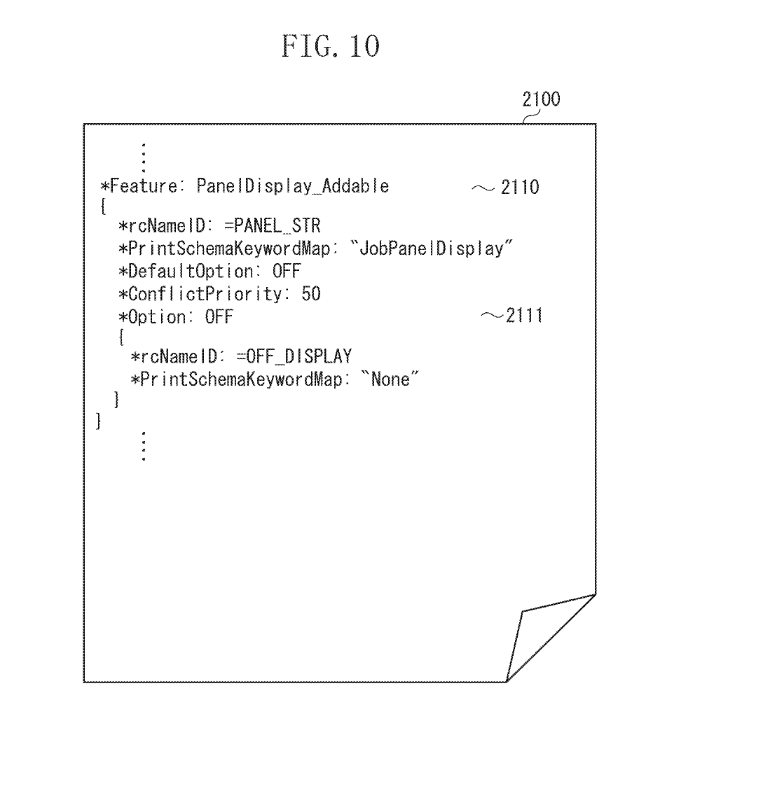

FIG. 10 illustrates a GPD file 2100 excerpted from the GPD file used to display the UI illustrated in FIG. 9. The GPD file 2100 has Feature, which is provided with a keyword of “_Addable” at the end thereof beforehand by a print manufacturer. The Feature corresponds to the print setting in which an arbitrary character string is addable. As illustrated in FIG. 10, the Feature is provided with “PanelDisplay_Addable” 2110 as such a keyword. The driver replacement tool 300 checks whether the keyword of “_Addable” is provided at the end of Feature when generating the tree display 1250. In one embodiment of the present invention, only when the keyword is provided, the driver replacement tool 300 adds the item “+ADD OPTION” 1212.

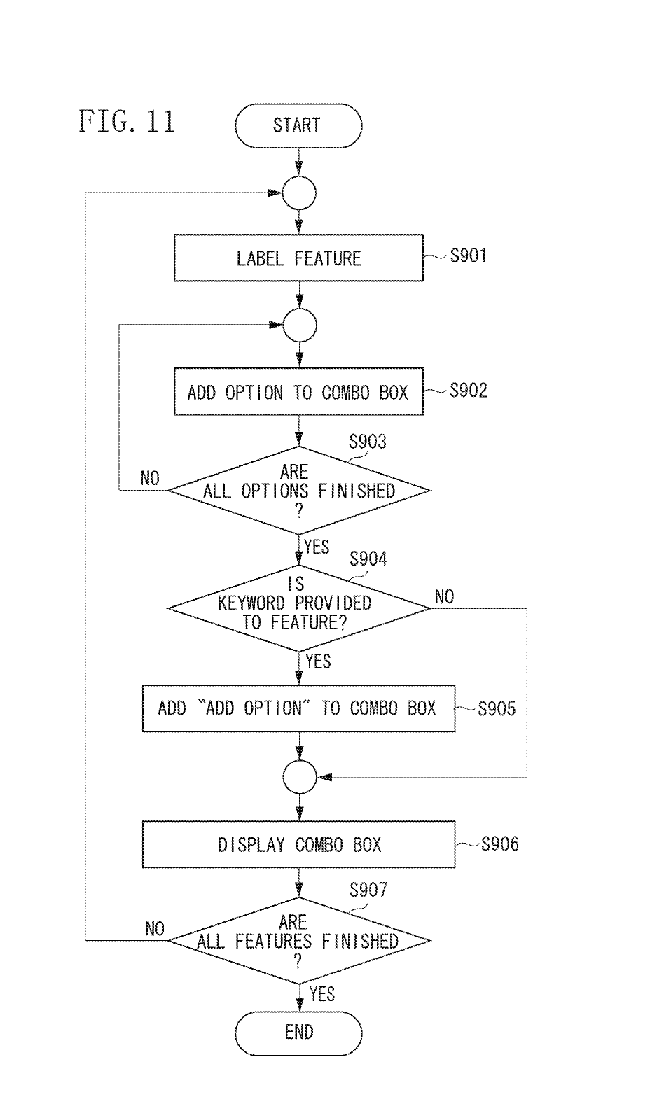

FIG. 11 is a flowchart illustrating operation of the driver replacement tool 300 to generate the tree display 1250 based on the GPD file 461. In step S901, the driver replacement tool 300 causes a first Feature of the GPD file to be labeled. In step S902, the driver replacement tool 300 adds a first Option to a combo box. In step S903, the driver replacement tool 300 repeats such addition until all the Options of the Feature are added. In step S904, the driver replacement tool 300 checks whether the keyword is provided at the end of the Feature. Only when the keyword is provided (YES in step S904), in step S905, the driver replacement tool 300 adds an item “+ADD OPTION” in the last place of the combo box. Subsequently, in step S906, the driver replacement tool 300 displays the combo box corresponding to the Feature. In step S907, the driver replacement tool 300 repeats steps S901 through S906 with respect to all the Features, and completes the generation of the tree display 1250.

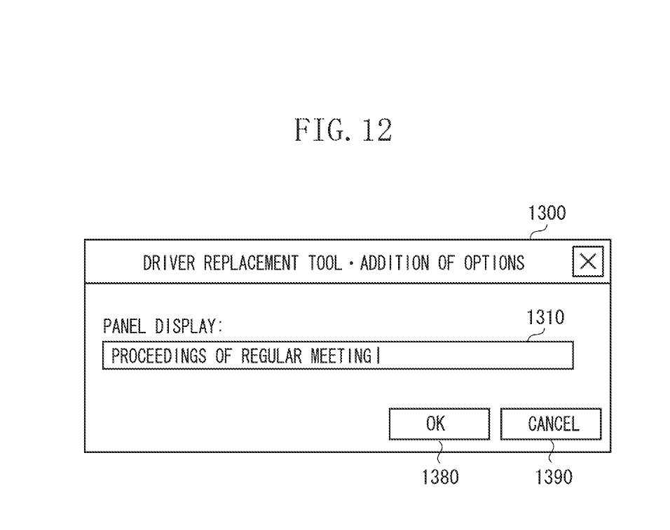

FIG. 12 illustrates a dialog box 1300 to be displayed by the driver replacement tool 300 when the user selects the item “+ADD OPTION” 1212. In the dialog box 1300, an edit box 1310 in which an arbitrary character string can be input is illustrated. When the user presses an “OK” button 1380, the driver replacement tool 300 closes the dialog box 1300 and adds the character string input to the edit box 1310 to the combo box 1210. Meanwhile, when the user presses a “CANCEL” button 1390, the driver replacement tool 300 discards the character string input to the edit box 1310 and closes the dialog box 1300.

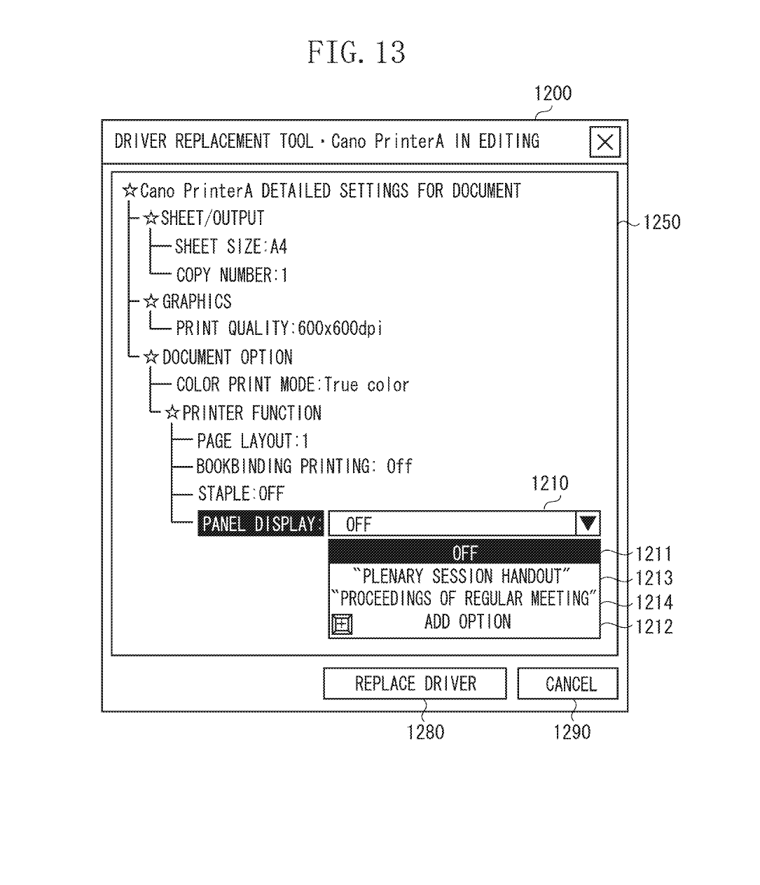

FIG. 13 illustrates a UI of the driver replacement tool 300 when two arbitrary character strings are added to the combo box 1210 for “PANEL DISPLAY:” by the user. The two character strings are “PLENARY SESSION HANDOUT” as an item 1213, and “PROCEEDINGS OF REGULAR MEETING” as an item 1214 in FIG. 13. Accordingly, when the “+ADD OPTION” item 1212 is selected, a plurality of arbitrary character strings can be added.

As illustrated in FIG. 9 and FIG. 13, the setting screen 1200 of the driver replacement tool 300 has a “REPLACE DRIVER” button 1280 and a “CANCEL” button 1290. The driver replacement tool 300 receives the editing of UI until the button 1280 or 1290 is pressed.

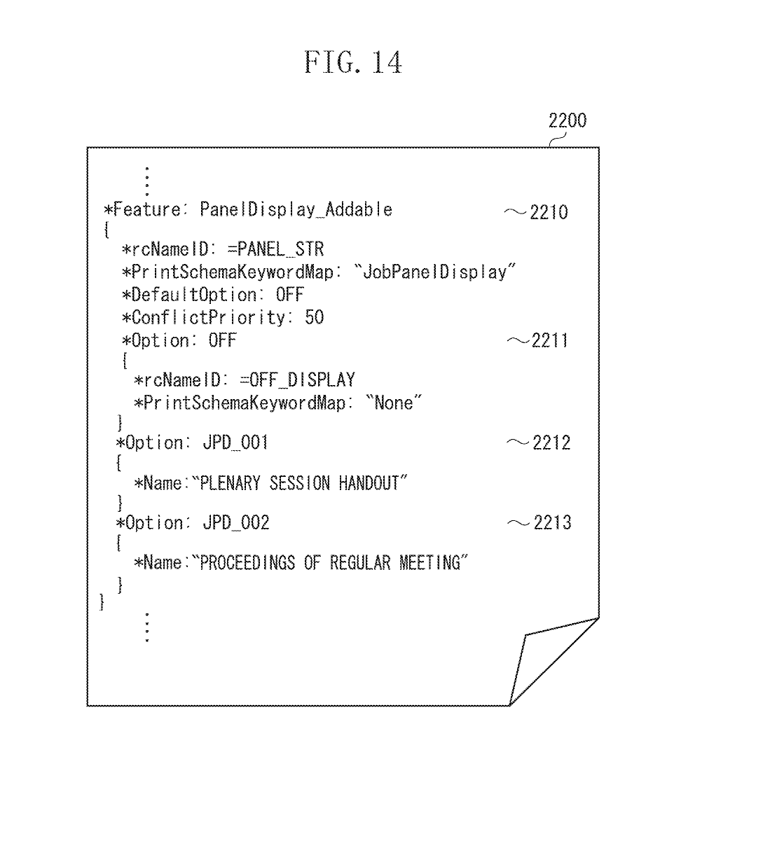

In step S604 illustrated in FIG. 7, if the “REPLACE DRIVER” button 1280 is pressed (YES in step S604), then in step S605, the driver replacement tool 300 generates a GPD file based on the edited UI, and creates a new driver set in the work folder 350. FIG. 14 is an example of the GPD file to be generated by the driver replacement tool 300 when the user performs the editing as illustrated in FIG. 13. As illustrated in FIG. 14, in addition to the existing Option of “OFF” 2211, “JPD_001” 2212 and “JPD_002” 2213 are added with respect to Feature provided with “PanelDisplay_Addable” in a new GPD file 2200. In other words, the new GPD file 2200 indicates that “PLENARY SESSION HANDOUT” and “PROCEEDINGS OF REGULAR MEETING” have been added with respect to the combo box. In addition, the new driver set created using the edited GPD file is stored in the work folder 350.

Finally, in step S606, the driver replacement tool 300 replaces the driver of the selected printer with the new driver set. Therefore, when the user opens a printer driver UI next time, the user can select the added arbitrary character string from the combo box. The printer driver can be replaced by, for example, a method in which a current printer driver is once uninstalled and then a new driver set is installed, or a method in which a current printer driver is updated with a new driver set using a function of the operating system 400. In the former method, the driver replacement tool 300 stores a printer name and port information of a target printer to be uninstalled in the RAM 102, so that the driver replacement tool 300 can use the stored printer name and port information when installing the uninstalled printer next time. Accordingly, the user can continue to use the printer having the same name as before without consciousness of the printer driver replacement.

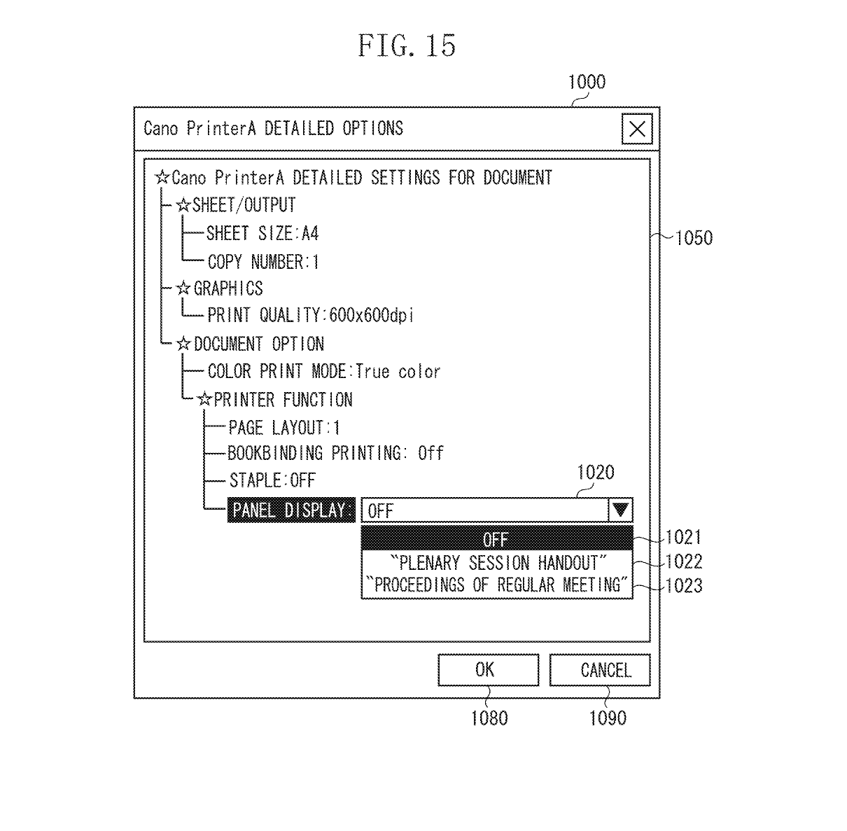

FIG. 15 illustrates the printer driver UI 1000 opened by the user subsequent to the replacement of the printer in step S606. In comparison with the printer driver UI 1000 prior to the replacement of the printer as illustrated in FIG. 6, the printer driver UI 1000 illustrated in FIG. 15 has an item “PLENARY SESSION HANDOUT” 1022 and an item “PROCEEDINGS OF REGULAR MEETING” 1023 which are setting items added to a combo box 1020 for “PANEL DISPLAY:”.

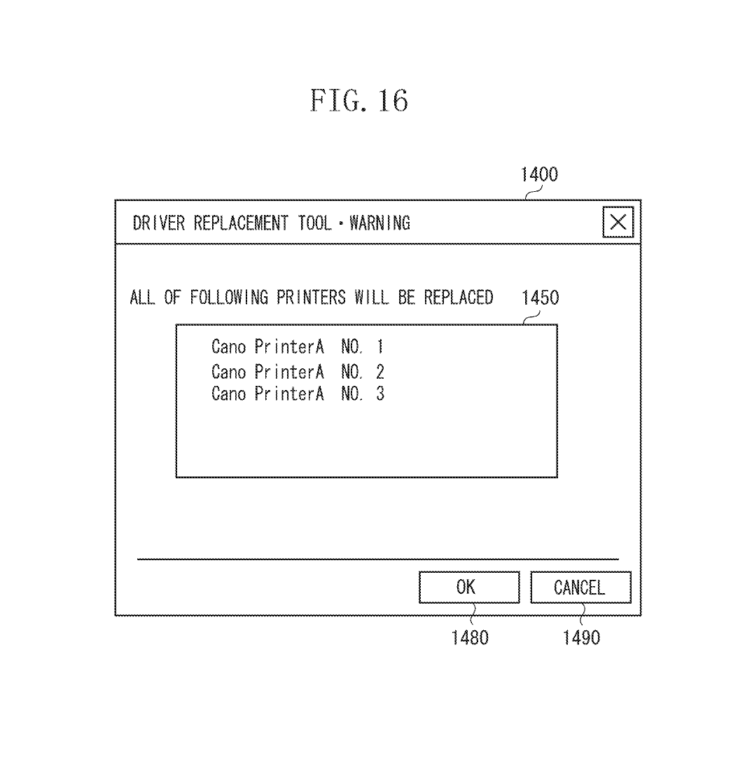

When the driver is replaced in step S606, the user needs to pay attention to the fact that all printers having the same model name as the printer selected on the printer selection screen 1100 illustrated in FIG. 8 are to be replaced. In the example illustrated in FIG. 8, the printers as the items 1111 through 1113 are operated by the printer driver of “Cano Printer A”, whereas the printers as the items 1114 and 1115 are operated by the printer driver of “Cano PrinterB”. When the user selects the printer of the item “Cano PrinterA No. 1” 1111 to replace the printer driver, the other two printers sharing the same printer driver are also replaced. The driver replacement tool 300 can urge the user to pay attention to such replacement by displaying a dialog 1400 illustrated in FIG. 16, for example. As illustrated in FIG. 16, all of target printers to be replaced are listed in a list box 1450. Only when the user presses an “OK” button 1480, the driver replacement tool 300 replaces the printer driver. When the user presses a “CANCEL” button 1490, on the other hand, the driver replacement tool 300 does not replace the printer driver.

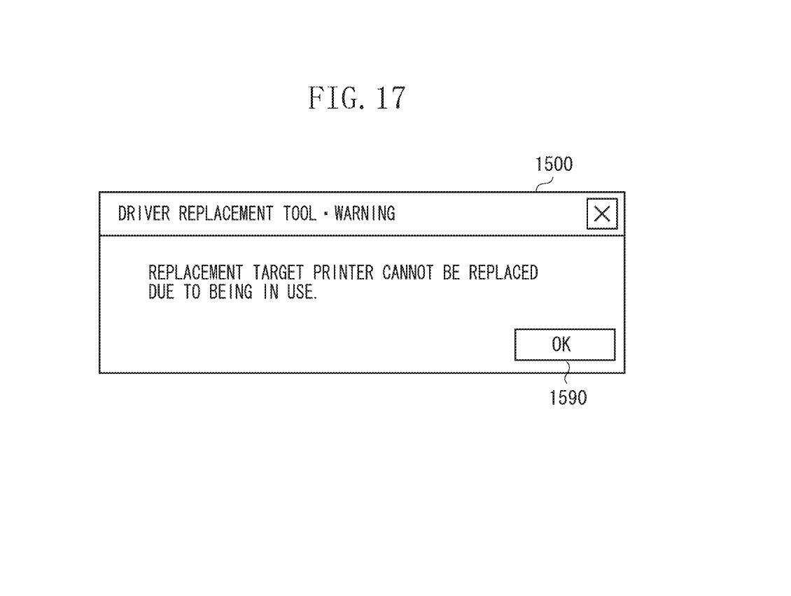

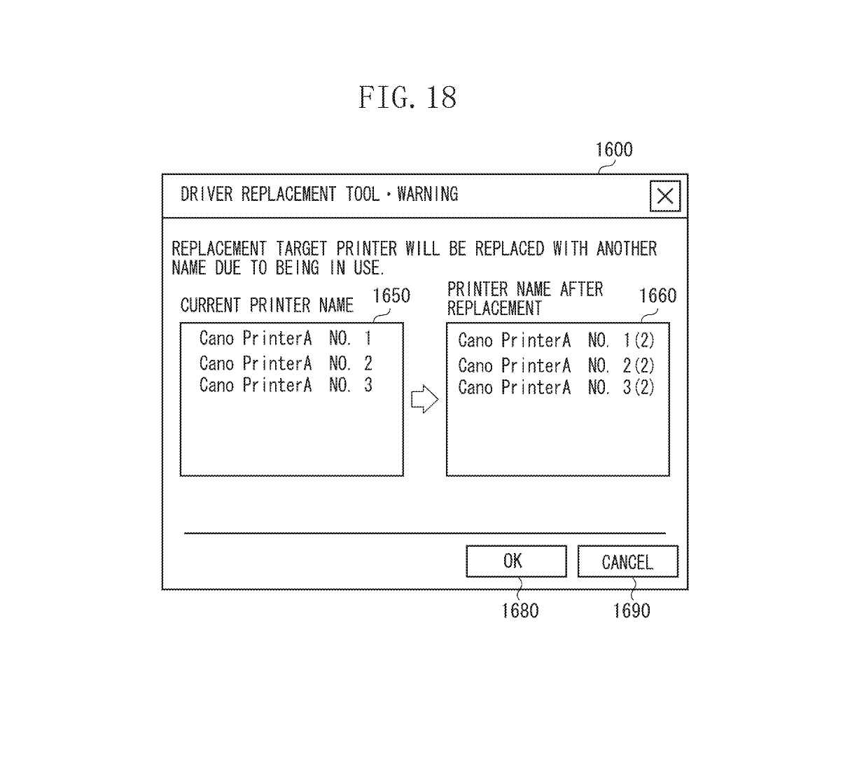

If a target printer driver is in use at timing of driver replacement, the driver replacement tool 300 cannot replace the printer driver. In such a situation, the driver replacement tool 300 displays a warning dialog 1500 illustrated in FIG. 17 to the user. When an “OK” button 1590 is pressed, the driver replacement tool 300 closes the dialog 1500. When the user stops using the printer and presses the “REPLACE DRIVER” button 1280, the user can attempt to replace the printer driver again. Moreover, even if a printer driver is in use, a new driver set can be installed by changing a model name of the printer driver. In such a situation, the driver replacement tool 300 can display a dialog 1600 illustrated in FIG. 18 to the user, the dialog 1600 indicating a name of a printer to be newly installed. In this case, when an “OK” button 1680 is pressed, the driver replacement tool 300 replaces the printer driver. When a “CANCEL” button 1690 is pressed, on the other hand, the printer driver is not replaced. Therefore, even when a target printer driver is in use at timing of driver replacement, the user can be provided with a printer driver newly created by an appropriate manner. FIG. 18 illustrates an example of the UI when all the printers of the relevant printer driver are installed again. Alternatively, the driver replacement tool 300 may control such that only a selected printer is newly installed.

The driver replacement tool 300 of the present invention, therefore, operates by following the flowchart illustrated in FIG. 7, so that a user is permitted to input a desired arbitrary character string and to designate a print setting on a GPD-based printer driver. As similar to the other print settings, the arbitrary character string input as a print setting is input to the rendering module 464 by the operating system 400 when printing is performed by the application 200. The rendering module 464 converts the arbitrary character string into a format (PDL) interpretable by the printer 800, and transmits the converted character string to the printer 800 as a portion of print data. According to the present exemplary embodiment, an arbitrary character string designated by the “PANEL DISPLAY:” is transmitted to the printer 800, so that the printer 800 displays the transmitted character string on a panel (e.g., a liquid crystal display (LCD) or a liquid crystal panel). The rendering module 464 creates PDL based on the supplied print setting. Since the rendering module 464 creates the PDL by a known method, a description of such a method is omitted.

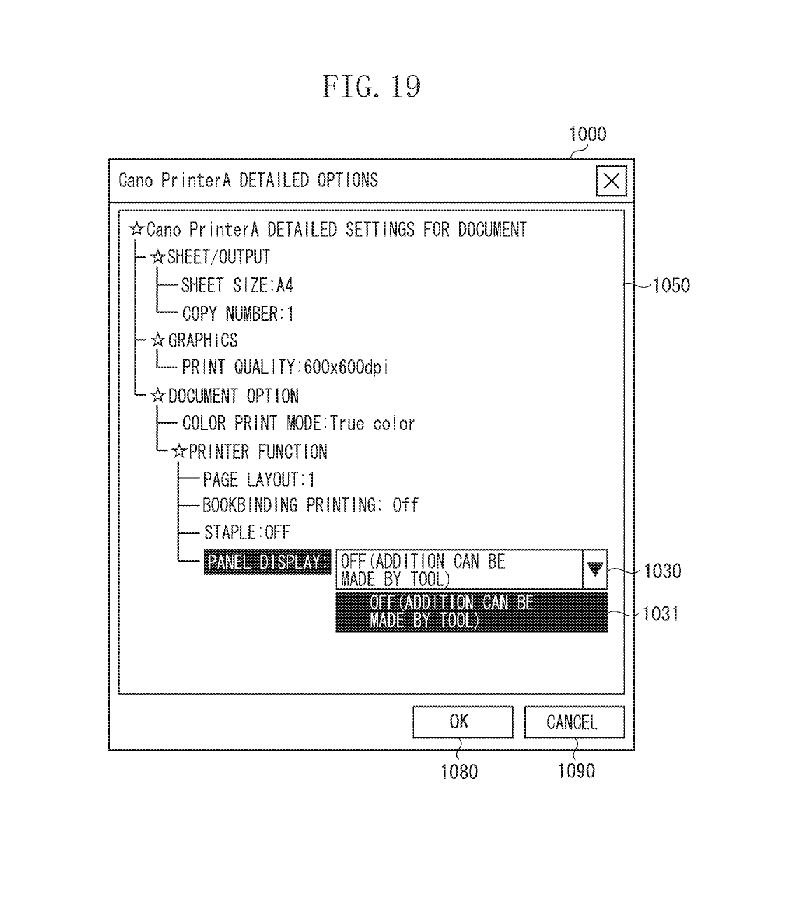

In FIG. 6 of the present exemplary embodiment, only the item “OFF” 1021 is registered in the combo box 1020 for the item “PANEL DISPLAY:”. Alternatively, a method for increasing the number of options may be displayed to the user as illustrated in FIG. 19. In a combo box 1030 for “PANEL DISPLAY:” illustrated in FIG. 19, an item “OFF (ADDITION CAN BE MADE BY TOOL)” 1031 is displayed as an option. Specifically, the above described character string can be recorded beforehand in the resource file 463 of the driver set 460. Accordingly, the printer driver UI 1000 can display thereon an urge to use the driver replacement tool 300, thereby increasing usability.

The description of the exemplary embodiment of the present invention has been made on the example case where the panel display character string is input. However, the exemplary embodiment may be applied to a case where a character string to be printed in a header or footer of a print document is input to a printer driver, or a character string of user name is input to a printer driver. The user name may be used for secure print, for example.

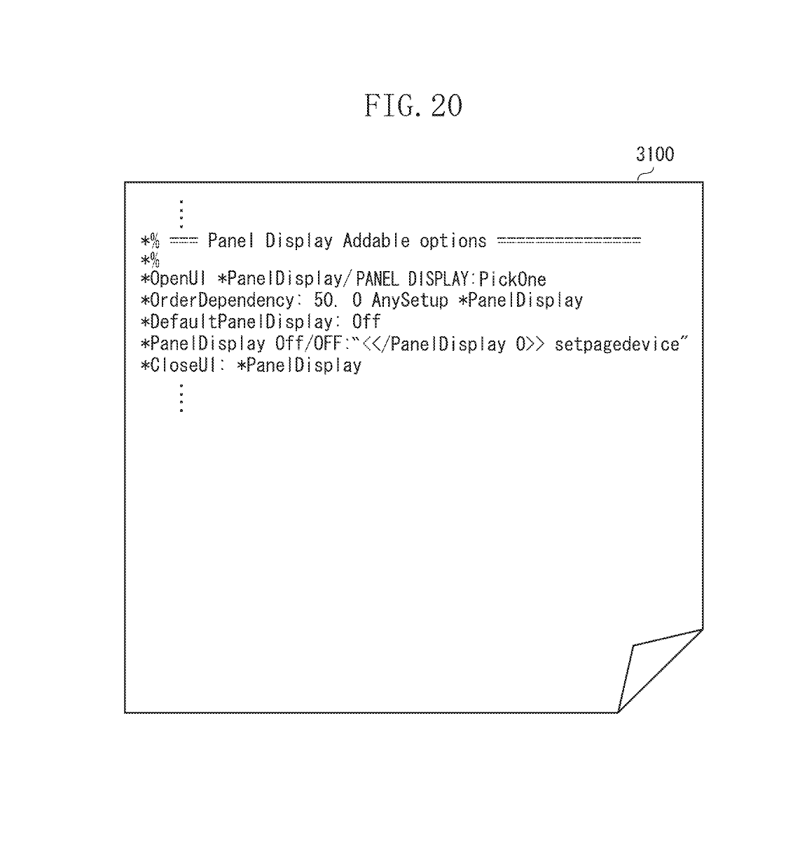

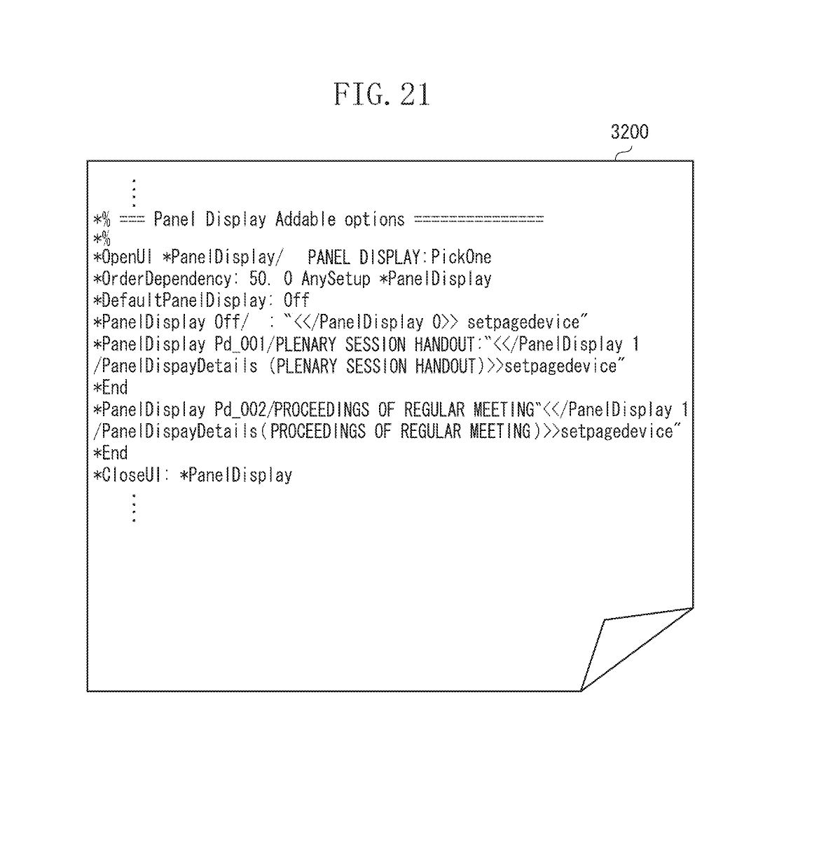

Moreover, the description of the present exemplary embodiment has been made on the GPD-based printer driver. However, the present exemplary embodiment may be applied to a printer driver such as a PPD-based printer driver having the similar problem as the GPD-based printer driver. FIG. 20 illustrates a PPD file 3100 before editing is performed, and FIG. 21 illustrates a PPD file 3200 after editing is performed. Since FIGS. 20 and 21 have a relationship substantially the same as that of the FIGS. 10 and 14 in terms of GPD files described in the present exemplary embodiment, the description thereof is omitted.

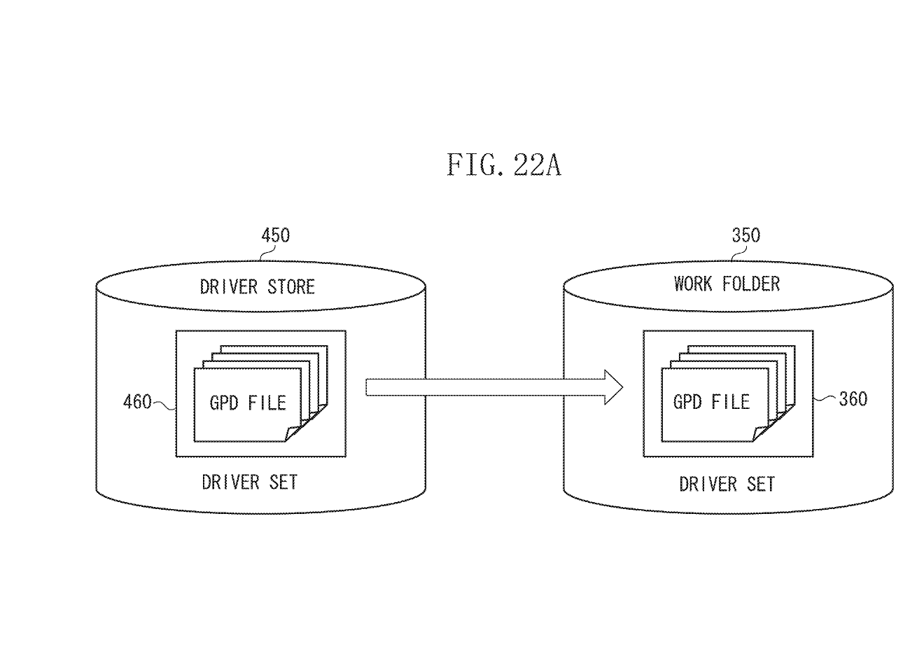

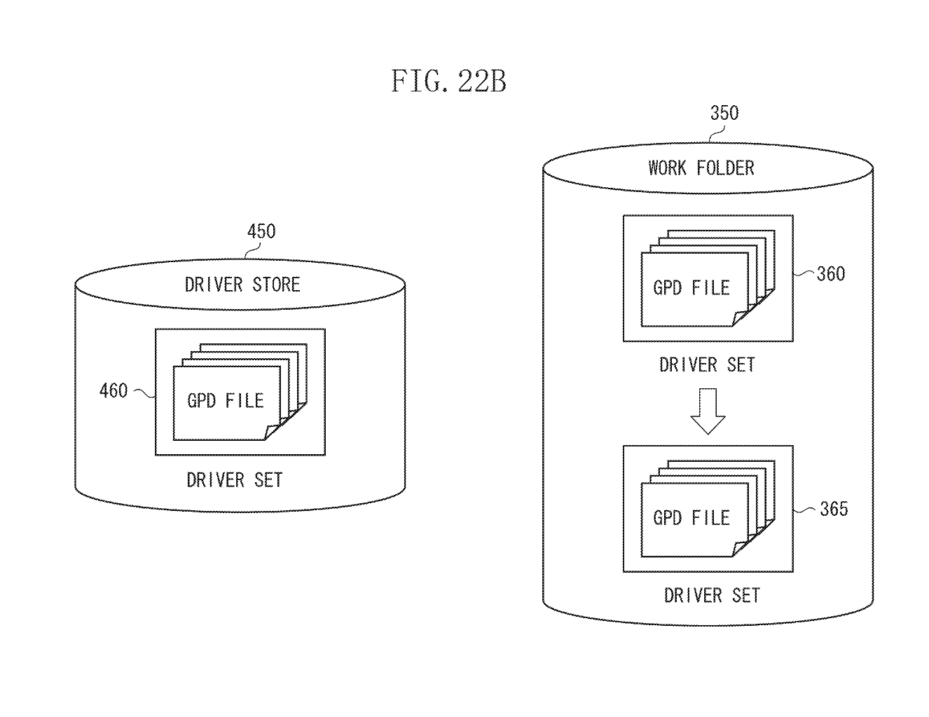

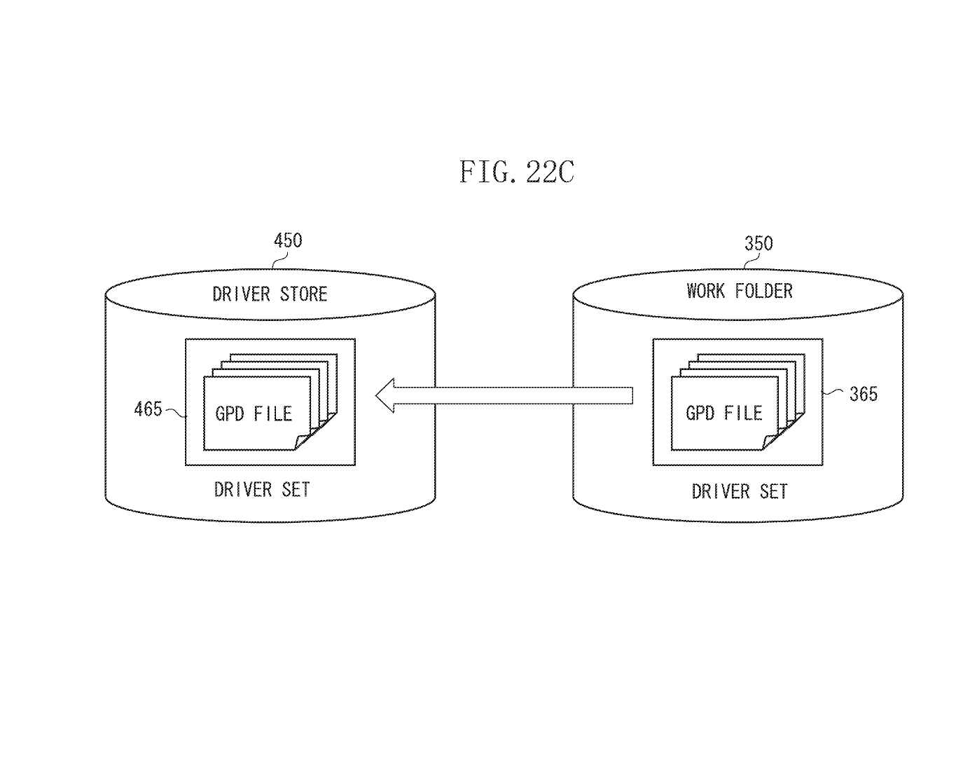

Lastly, FIGS. 22A through 22C illustrate movements of files in each steps of the flowchart illustrated in FIG. 7. FIG. 22A illustrates a movement of the file in step S602. The driver replacement tool 300 acquires the driver set 460 from the driver store 450, and copies the driver set 460 into the work folder 350 as a driver set 360. FIG. 22B illustrates a movement of the file in step S605. When the “REPLACE DRIVER” button 1280 is pressed by the user in step S604, the driver replacement tool 300 converts the driver set 360 into a driver set 365 in the work folder 350. FIG. 22C illustrates a movement of the file in step S606. The driver replacement tool 300 replaces the driver set 460 inside the driver store 450 with the new driver set 365 inside the work folder 350, and then sets the new driver set 365 as a driver set 465.

According to the present exemplary embodiment of the present invention, therefore, a GPD-based printer driver can provide a printer driver capable of causing a user to input a substantially arbitrary character string. Moreover, when the user inputs the arbitrary character string, the user does not need to prepare or consider a driver set before being installed, or does not need to perform an installation work, thereby providing a high-convenience environment.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., non-transitory computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-139736 filed Jun. 23, 2011, which is hereby incorporated by reference herein in its entirety.

What is claimed is:

1. An information processing apparatus comprising:
an acquisition unit configured to acquire an installed driver set;
a display unit configured to display an input screen for inputting a character string thereto;
a creation unit configured to create a new driver set by editing the driver set acquired by the acquisition unit based on the character string input to the input screen; and
a replacement unit configured to replace the installed driver set with the new driver set created by the creation unit.

2. The information processing apparatus according to claim 1, wherein the display unit is configured, based on the driver set acquired by the acquisition unit, to display a setting screen, and is configured, when an instruction to add an option is received from the setting screen, to display the input screen for inputting the character string thereto.

3. The information processing apparatus according to claim 2, wherein the setting screen includes a print setting capable of adding an option, and a print setting not capable of adding the option.

4. The information processing apparatus according to claim 1, wherein the replacement unit is configured to uninstall the installed driver set, and install the created driver set.

5. The information processing apparatus according to claim 4, wherein the replacement unit is configured to store a printer name and port information at the time of uninstallation, and use the stored printer name and the stored port information at the time of installation.

6. The information processing apparatus according to claim 1, wherein the replacement unit is configured, when the driver set is in use at the time of replacement, to provide a warning to a user.

7. The information processing apparatus according claim 1, wherein the replacement unit is configured, when the driver set is in use at the time of replacement, to perform installation by changing a model name.

8. An information processing method comprising:
acquiring an installed driver set;
displaying an input screen for inputting a character string thereto;
creating, based on the character string input to the input screen, a new driver set by editing the acquired driver set; and
replacing the installed driver set with the new driver set created by the creating step.

9. The information processing method according to claim 8, wherein the displaying step displays, based on the driver set acquired by the acquiring step, a setting screen, and displays, when an instruction to add an option is received from the setting screen, the input screen for inputting the character string thereto.

10. The information processing method according to claim 9, wherein the setting screen includes a print setting capable of adding an option, and a print setting not capable of adding the option.

11. The information processing method according to claim 8, wherein the replacing step uninstalls the installed driver set, and installs the created driver set.

12. The information processing method according to claim 11, wherein the replacing step stores a printer name and port information at the time of uninstallation, and uses the stored printer name and the stored port information at the time of installation.

13. The information processing method according to claim 8, wherein the replacing step, when the driver set is in use at the time of replacement, provides a warning to a user.

14. The information processing method according to claim 8, wherein the replacing step performs, when the driver set is in use at the time of replacement, installation by changing a model name.

15. A non-transitory storage medium storing a program for causing a computer to perform operations comprising:
acquiring an installed driver set;
displaying an input screen for inputting a character string thereto;
creating, based on the character string input to the input screen, a new driver set by editing the acquired driver set; and
replacing the installed driver set with the new driver set created by the creating step.

16. The non-transitory storage medium storing the program according to claim 15, wherein the displaying step displays, based on the driver set acquired by the acquiring step, a setting screen, and displays, when an instruction to add an option is received from the setting screen, the input screen for inputting the character string thereto.

17. The non-transitory storage medium storing the program according to claim 16, wherein the setting screen includes a print setting capable of adding an option, and a print setting not capable of adding the option.

18. The non-transitory storage medium storing the program according to claim 15, wherein the replacing step uninstalls the installed driver set, and installs the created driver set.

19. The non-transitory storage medium storing the program according to claim 18, wherein the replacing step stores a printer name and port information at the time of uninstallation, and uses the stored printer name and the stored port information at the time of installation.

20. The non-transitory storage medium storing therein the program according to claim 15, wherein the replacing step provides, when the driver set is in use at the time of replacement, a warning to a user.

21. The non-transitory storage medium storing therein the program according to claim 15, wherein the replacing step performs, when the driver set is in use at the time of replacement, an installation by changing the model name.
